(19) United States
(12) Patent Application Publication
(10) Pub. No.: US 2014/0236823 A1
(43) Pub. Date: Aug. 21, 2014

(54) Online Prepaid Gift Card Identification

(71) Applicant: Seung Hyo Lee, San Jose, CA (US)

(72) Inventor: Seung Hyo Lee, San Jose, CA (US)

(21) Appl. No.: 13/772,108

(22) Filed: Feb. 20, 2013

(51) Int. Cl. G06Q 20/40

(52) U.S. Cl. CPC G06Q 20/409
USPC 705/44

(57) ABSTRACT

Methods and systems are provided for authorizing online purchase transactions made with non-reloadable prepaid cards, such as gift cards. An online purchase transaction using a non-reloadable prepaid card can be identified by performing a balance inquiry and an Address Verification System (AVS) inquiry. If the balance inquiry results in a positive balance and the AVS inquiry returns an indication that the billing address is not supported and/or that information is not available, then the card being authorized can be identified as the non-reloadable prepaid gift card.

### BACKGROUND

1. Technical Field

The present disclosure generally relates to electronic commerce and, more particularly, relates to methods and systems for identifying non-reloadable prepaid gift cards to facilitate authorization of online purchase transactions performed therewith without compromising the security level of other card types.

2. Related Art

Prepaid gift cards are well known. Prepaid gift cards are frequently given as gifts for birthdays, Christmas, weddings, and the like. The purchase of a prepaid gift card makes it much easier for the gift giver to select the gift. It also helps to assure that the gift recipient ultimately receives a gift that the recipient will enjoy. The use of prepaid gift cards thus tends to mitigate much of the uncertainty and inconvenience frequently associated with the gift purchasing process. Prepaid gift cards can be branded by card companies, such as by Visa, MasterCard and American Express. Prepaid gift cards can be branded by merchants.

Prepaid gift cards can be either reloadable or non-reloadable. A reloadable prepaid gift card can have money added thereto after the initially loaded money is substantially used up. A reloadable prepaid gift card can theoretically be used to make purchases and can be reloaded indefinitely. As such, a reloadable prepaid gift card can be used many times.

A non-reloadable prepaid gift card can only be loaded with money once, such as prior to or during the purchase. The non-reloadable prepaid gift card cannot be reloaded with money after the initial loading. Thus, money cannot repeatedly be added to the non-reloadable prepaid gift card after the initial loading thereof. The user of a non-reloadable prepaid gift card is constrained to use of the money initially loaded into the prepaid gift card. As such, a non-reloadable prepaid gift card can only be used a limited number of times, i.e., until the money amount of the non-reloadable prepaid gift card runs out. The non-reloadable prepaid gift card can be used for brick-and-mortar store purchases and online purchases.

### BRIEF DESCRIPTION OF THE DRAWINGS

FIG. 1 is a block diagram of a system for non-reloadable prepaid card identification, according to an embodiment;

FIG. 2 is a flow chart showing a method for non-reloadable prepaid card identification, according to an embodiment;

FIG. 3 is a flow chart showing further detail of the method for non-reloadable prepaid card identification, according to an embodiment; and

FIG. 4 is a block diagram of an example of a computer that is suitable for use in the system for non-reloadable prepaid card identification, according to an embodiment.

### DETAILED DESCRIPTION

It can be difficult for a merchant to identify a card being used in a card-not-present purchase transaction, such as an online purchase transaction, as a prepaid gift card. Generally, a bank identification number (BIN) code is needed for such identification. The BIN code must generally be obtained from the card processor or card brand. Obtaining the BIN from the card processor or card brand adds an additional step to the authentication process, thus undesirably increasing the complexity and time required for the authentication process.

As discussed above, prepaid cards such as gift cards can be either reloadable or non-reloadable. A reloadable prepaid card can have money added thereto after the purchase of the prepaid card and thus can be used many times. A non-reloadable prepaid card cannot have money added thereto after the purchase of the prepaid card and can thus only be used a limited number of times, i.e., until the money amount of the non-reloadable prepaid card runs out.

Methods and systems are provided for identifying non-reloadable prepaid cards. Such identification can be used, at least in part, according to an embodiment, such identification can be done without the BIN code, thus eliminating the necessity of contacting the card processor or card brand to obtain the BIN code.

According to an embodiment, a non-reloadable prepaid card can be identified, at least to some degree, by performing both a balance inquiry and an address inquiry for a card being used in an online purchase transaction. The balance inquiry and address inquiry can be performed by querying card processors. The card processors can be card companies, such as the card issuers. The card processors can be dedicated card processors. The card processors can be banks, payment providers, credit card companies, or any other entities.

Generally, if the balance inquiry returns any valid information, then the card is some type of prepaid card, rather than a credit. Credit cards do not generally carry such balances, e.g., positive money balances, because the user generally does not have money on deposit for credit cards and debit cards. On the other hand, prepaid cards, including reloadable prepaid cards and non-reloadable prepaid cards, will have a positive money balance (such as the prepaid amount or some portion thereof).

The address inquiry can be an Address Verification System (AVS) inquiry. The Address verification System attempts to match an address or a portion of an address that is purported to be associated with a card to a billing address for the card in a database. A match, partial match, or non-match of the address can be a factor in determining whether or not to approve an online purchase transaction. Generally, prepaid gift cards do not have a billing address. The AVS system is discussed in further detail below.

A reloadable prepaid card will generally return a match (or at least a partial match or mismatch) as the result of the AVS inquiry. By way of contrast, a non-reloadable prepaid card will generally return a code indicating that the address verification is not supported or available, as the result of an AVS inquiry. If the AVS inquiry returns an indication that the address verification is not supported or available, and the balance inquiry returns a positive balance, then it can be assumed with responsible confidence that the card is a non-reloadable prepaid card, such as a gift card.

Thus, the balance inquiry and the AVS inquiry can be used to provide an indication that a card being used in an online purchase transaction is a non-reloadable prepaid card. For example, a card being used in an online purchase transaction can be identified as a non-reloadable prepaid card. Authorization of the online purchase transaction can more readily be facilitated and the payment can be processed. The balance inquiry and the AVS inquiry can be used as part of an authorization request response without any pre-vetting by card processors or card brands. Currently, this method can be used to determine that a card is likely to be a non-reloadable prepaid card in the United States, the United Kingdom, and Canada. Use of this method in other countries is contemplated.

The address for the address inquiry can be provided by a payment provider, such as PayPal, Inc. The address can be a billing address of the user. The address can be a billing address associated with the non-reloadable prepaid card, a billing address associated with a different card, or any other address such as an address that is or is not a billing address. The address can be the user's payment provider billing address or any other address provided to, obtained by, and/or stored by the payment provider. For example, the billing address can be the user's PayPal billing address. Alternatively, the purchase transaction can be performed without using any billing address.

The address for the address inquiry can be provided by a user's mobile device. For example, an app of the user's mobile device can be selected and run by the user to provide an address to a merchant device of the online store. The address can be provided by the mobile device to the merchant device wirelessly, such as via WiFi, Bluetooth, or any other wireless means.

The address for the address inquiry can be provided automatically by a user's mobile device. The user or an administrator can determine, such as via a set up process, whether or not the address is provided automatically by the user's mobile device. User authorized can be required, such as on a case-by-case basis, for the user's mobile device to provide the address.

The entire address can be used for the address inquiry. Alternatively, a portion of the address can be used for the billing inquiry. For example, only the ZIP code can be used for the billing inquiry. Any desired portion of the address can be used for the address inquiry.

Thus, according to an embodiment, the user does not have to provide the merchant with an address to facilitate authorization of the online purchase transaction. For example, the user is spared the inconvenience of having to fill out a form with the user's billing address to facilitate the online purchase transaction. The identification of the card and/or authorization of the online purchase transaction can be performed via the payment provider or other entity/device.

According to an embodiment, a system can comprise one or more memories that store information about the non-reloadable prepaid card or that store information about a non-reloadable prepaid card account. One or more hardware processors can be in communication with the one or more memories.

The one or more hardware processors can be operable to receive a first communication including an indication of a desire of a user to perform an online purchase transaction using a non-reloadable prepaid card. The one or more hardware processors can perform a balance inquiry for the non-reloadable prepaid card and perform an address inquiry for the non-reloadable prepaid card.

The one or more hardware processors can be further operable to determine, at least in part from the balance inquiry and the address inquiry, if the card is a non-reloadable prepaid card and/or if the purchase transaction, such as an online purchase transaction, is to be authorized. If the card is determined to be a non-reloadable prepaid card, then the one more hardware processors can send a second communication including an indication that the card is a non-reloadable prepaid card and/or that the online purchase transaction can be authorized. The payment can then be processed.

The card can be determined to be a non-reloadable prepaid card, at least in part, if two different criteria are met. The card can be determined to be a non-reloadable prepaid card, at least in part, if the balance inquiry returns an indication that there is a positive balance and if the address inquiry returns an indication that the non-reloadable prepaid card is not supported or that information regarding the non-reloadable prepaid card is not available. Other criteria can additionally be used (or not used) to determine if the card is to be identified as a non-reloadable prepaid card and/or if the online purchase transaction is to be authorized.

As an example of such other criteria, the one or more hardware processors can be further operable to determine if the balance is sufficient to cover the online purchase transaction and can then only determine that the online purchase transaction is to be authorized if the balance is sufficient to cover the online purchase transaction. Thus, the merchant can be assured that the amount of the online purchase is covered by the non-reloadable prepaid card.

Thus, according to an embodiment, at least two conditions must be met in order to determine that the card is a non-reloadable prepaid card. First, the balance inquiry must return an indication that there is a balance, e.g., a positive balance. Second, the address inquiry must return an indication that the non-reloadable prepaid card is not supported or that information regarding the non-reloadable prepaid card is not available

The balance inquiry can made via the non-reloadable prepaid card issuer. Thus, the issuer of the non-reloadable prepaid card can be queried regarding the balance, or amount of money remaining on the non-reloadable prepaid card. The non-reloadable prepaid card issuer can be a bank, a credit card company, a merchant, or any other entity. The non-reloadable prepaid card issuer can be the entity that maintains, e.g., stores in a database, the balance for the non-reloadable prepaid card.

The one or more processors can query the Address Verification System (AVS). AVS is a system that is used by merchants and the like to verify the name and address of a person attempting to perform an online purchase transaction with a credit card. According to contemporary practice, AVS checks the billing address for the credit card as provided by the purchaser with the billing address on file at the credit card company for the credit card. If the billing address for the credit card as provided by the purchaser does not sufficiently match the billing address on file at the credit card company for the credit card, then the transaction can be denied. Numeric information, such as the street address and zip code are typically checked.

A code is returned in response to an AVS query, as discussed herein. The indication that the non-reloadable prepaid card is not supported or that information regarding the non-reloadable prepaid card is not available can be provided by the AVS inquiry returning a code of U or a code of S.

Various address systems can be used. Each verification system can have its own unique response codes. For example, North American response codes are commonly used in North American and international response codes are commonly used elsewhere.

Examples of the North American response codes are as follows:

X—indicates an exact match, wherein the street address and nine digit ZIP Code match.
Y—indicates an exact match, wherein the street address and five digit ZIP Code match.
A—indicates a partial match, wherein the street address matches, but the ZIP Code does not match.
W—indicates a partial match, wherein the ZIP Code matches, but the street address does not match.
Z—indicates a partial match, wherein only the five digit ZIP Code matches.
N—indicates no match, wherein the address and ZIP Code do not match.
U—indicates that the address information is unavailable for the account number or the card issuer does not support the request for address information.
G—indicates service not supported, wherein non-US card issuer does not participate in requests for address information.
R—indicates retry, such as when the card issuer system is temporarily unavailable.
E—indicates that the transaction is not a mail or phone order.
S—indicates service not supported.
Q—indicates bill to address did not pass edit checks and/or the Card Association could not authenticate of the address.
D—indicates an international street address and postal code match.
B—indicates an international street address match, wherein the postal code was not verified due to an incompatible format.
C—indicates international street address and postal code not verified due to incompatible formats.
P—indicates an international postal code match, wherein the street address was not verified due to an incompatible format.
1—indicates that the cardholder name matches.
2—indicates that the cardholder name, billing address, and postal code match.
3—indicates that the cardholder name and billing postal code match.
4—indicates that the cardholder name and billing address match.
5—indicates that the cardholder name is incorrect, but the billing address and postal code match.
6—indicates that the cardholder name is incorrect, but the billing postal code matches.
7—indicates that the cardholder name is incorrect, but the billing address matches.
8—indicates that the cardholder name, billing address, and postal code are all incorrect (no matches).

Examples of the Examples of international response codes are as follows:

G—indicates that the card is for a global non-AVS participant.
B—indicates that only the cardholder address matches.
C—indicates that the address and postal code do not match.
D—indicates that the address and postal code match.
F—indicates that the address and postal code match (UK only).
I—indicates that the address information has not been verified for an international transaction.
M—indicates that the address and postal code match.
P—indicates that only the postal code matches.

The first communication can be received from an online store. The first communication can be received from any place where the user attempts to make a purchase, such as a card-not-present purchase, with the non-reloadable prepaid card. The first communication can be received from any place from which the system can be accessed to determine if the non-reloadable prepaid card should be used in an online purchase transaction. For example, the first communication can be received from an online store, a brick and mortar store, from a vending truck, from a booth at a swap meet, from a booth at a trade show, or the like.

The second communication can be sent to the online store. The second communication can be sent to any other location, such as any location from which the first communication was received. The second communication can be sent to more than one recipient. For example, the second communication can be sent to the online store, to the user who is making the online purchase, to a credit reporting agency, and/or to any other entity.

According to an embodiment, a method can comprise storing, such as in one or more memories, information about a non-reloadable prepaid card account. The method can further comprise receiving, such as via one or more hardware processors in communication with the one or more memories, a first communication including an indication of a desire of a user to perform an online purchase transaction using a non-reloadable prepaid card.

The method can further comprise performing, such as via the one or more hardware processors, a balance inquiry for the non-reloadable prepaid card. The method can further comprise performing, such as via the one or more hardware processors, an address inquiry for the non-reloadable prepaid card. According to an embodiment, both the balance inquiry and the address inquiry are performed to identify a card as the non-reloadable prepaid card. According to an embodiment, either the balance inquiry or the address inquiry is performed to identify a card as the non-reloadable prepaid card.

The method can further comprise determining, such as via the one or more hardware processors and at least in part from the balance inquiry and/or the address inquiry, if the card is a non-reloadable prepaid card and/or if the online purchase transaction is to be authorized, as discussed herein. The method can further comprise sending, such as via the one or more hardware processors, a second communication including an indication that the card is a non-reloadable prepaid card and/or that the online purchase transaction is authorized if the card is a non-reloadable prepaid card and/or the online purchase transaction is determined to be authorized.

The card can be determined to be a non-reloadable prepaid card and/or the online purchase transaction can be determined to be authorized, at least in part, if the balance inquiry returns an indication that there is a positive balance and/or if the address inquiry returns an indication that the non-reloadable prepaid card is not supported or that information regarding the non-reloadable prepaid card is not available. Thus, one, two, or more criteria can be used to determine if the card is a non-reloadable prepaid card and/or if the online purchase transaction is to be authorized. According to an embodiment, at least two criteria must be met to determine that the card is a non-reloadable prepaid card, i.e., there must be a money balance for the card and/or the address inquiry must return an indication that the card is not supported or that information regarding the non-reloadable prepaid card is not available.

According to the method, the balance inquiry can be made via the non-reloadable prepaid card issuer. The address inquiry can be an AVS inquiry. The indication that the non-reloadable prepaid card is not supported or that information regarding the non-reloadable prepaid card is not available can be provided by the AVS inquiry returning a code of U or a code of S. The method can further comprise determining, via the one or more hardware processors, if the balance is sufficient to cover the online purchase transaction and only determining that the card is a non-reloadable prepaid card and/or that the online purchase transaction is to be authorized if the balance is sufficient to cover the online purchase transaction. The first communication can be received from online merchant or from any other place. The second communication can be sent to the online merchant or to any other place.

According to an embodiment, a computer program product can comprise a non-transitory computer readable medium. The non-transitory computer readable medium can have computer readable and executable code for instructing one or more processors to perform any of the methods discussed herein.

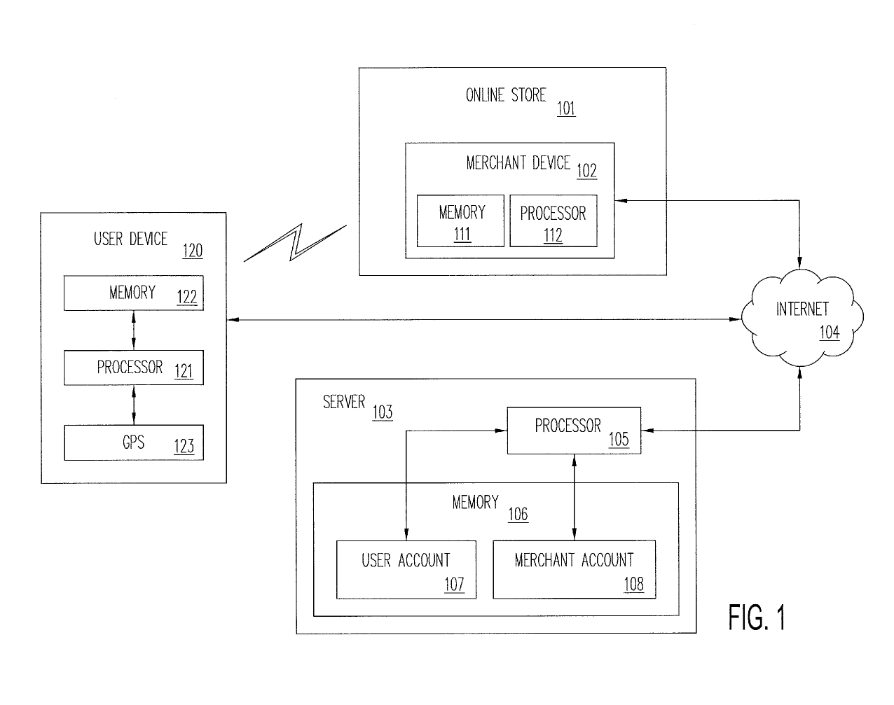

FIG. 1 is a block diagram of a system for identifying a non-reloadable prepaid card 110, according to an embodiment. The system can include a merchant device 102, a user's user device 120, and/or a payment server 103. The functions discussed herein can be split and/or shared among the merchant device 102, the user device 120, the payment server 130, and/or other devices, as desired. The merchant device 102 can be located at a store, such as an online store 101, for example.

The merchant device 102 can comprise an online merchant checkout terminal, a website, a computer, and/or a server, for example. The merchant device 102 can include a memory 111 and a processor 112. The merchant device 102 can be used for facilitating online purchase transactions and can be used for authorizing the use of cards, such as the non-reloadable prepaid card 110.

The user device 120 can comprise a desktop computer, a mobile computer, a tablet computer, a hand held computer, a laptop computer, a notebook computer, a smart phone, a cellular telephone, or any other device which can be used for online shopping. The user device 120 can be substantially stationary, such as at the user's home or office. The user device 120 can be carried by the user. The user device 120 can include a processor 121, a memory 122, and a global positioning system (GPS) 123. The user device 120 can communicate with an online store, such as a website, via a network such as the Internet. The user device 120 can communicate with an online store via a wide area network (WAN), a local area (LAN), a wireless network (such as a WiFi or WiMAX network), a cellular telephone or data network, or any other network or combination of networks.

The user device 120 can be used for routine telephone calls, text messaging, web browsing, and facilitating online purchase transactions. For example, the user device 120 can provide information regarding the user and/or the non-reloadable prepaid card 110. More particularly, the user device 120 can provide the merchant device 102 with the user's address, e.g., the user's billing address.

A mobile app can be stored in the memory 122 and executed by the processor 121. The app can be used for facilitating online purchase transactions. For example, the app can provide information regarding the user and/or the non-reloadable prepaid card 110. More particularly, the app can provide the merchant device 102 with the user's address, e.g., the user's billing address.

The non-reloadable prepaid gift card 110 can be embodied within the user device 120. For example, the user device 120 can define a token, such as a payment token that can be used for online purchase transactions much in the manner of a gift card. The user device 120 can be configured to communicate, such as with the merchant device 102, via Bluetooth, WiFi, or any other method.

The GPS 123 can be used for various processes associated with the purchase process. For example, the GPS 123 can be used for security purposes, such as by limiting use of the non-reloadable prepaid card 110 or any other card or device to use (such as for making purchases) within a particular geographic area. That is, the user can be required to be within a pre-defined geographic area in order to perform the online purchase.

The server 103 can comprise a server of a payment provider, such as PayPal, Inc. The server 103 can be a single server or can be a plurality of servers. The server 103 can include one or more processors 105 and one or more memories 106. The memory 106 can be a memory of the server 103 or a memory that is associated with the server 103. The memory 106 can be a distributed memory. The memory 106 can store a user account 107 and a merchant account 108, for example. The server 103 can be used for authorizing an online purchase transaction, such an online purchase transaction made via the payment provider. The server 103 can perform the balance inquiry and/or can perform the address inquiry. The server 103 can perform the balance inquiry and/or can perform the address inquiry autonomously or by cooperating with one or more other devices.

Generally, the merchant device 102, the user device 120, and the server 103 can perform functions discussed herein. That is, at least to some extent, a function that is discussed herein as being performed via one of these devices can often be performed by a different one of these devices or by a combination of these devices. For example, the merchant device 102, the server 103, and/or the user device 120, alone or in cooperation with one another, can perform the balance inquiry and/or can perform the address inquiry.

The merchant device 102, the user device 120, the other mobile devices 130, and the server 103 can communicate with one another via a network, such as the Internet 104. The merchant device 102, the user device 120, and the server 103 can communicate with one another via one or more networks, such as local area networks (LANs), wide area networks (WANs), cellular telephone networks, and the like. The merchant device 102, the user device 120, and the server 103 can communicate with one another, at least partially, via one or more near field communications (NFC) methods or other comparatively short range communications methods, such as infrared (IR), Bluetooth, WiFi, and WiMax.

FIG. 1 illustrates an exemplary embodiment of a network-based system for implementing one or more processes described herein. As shown, the network-based system may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or another suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

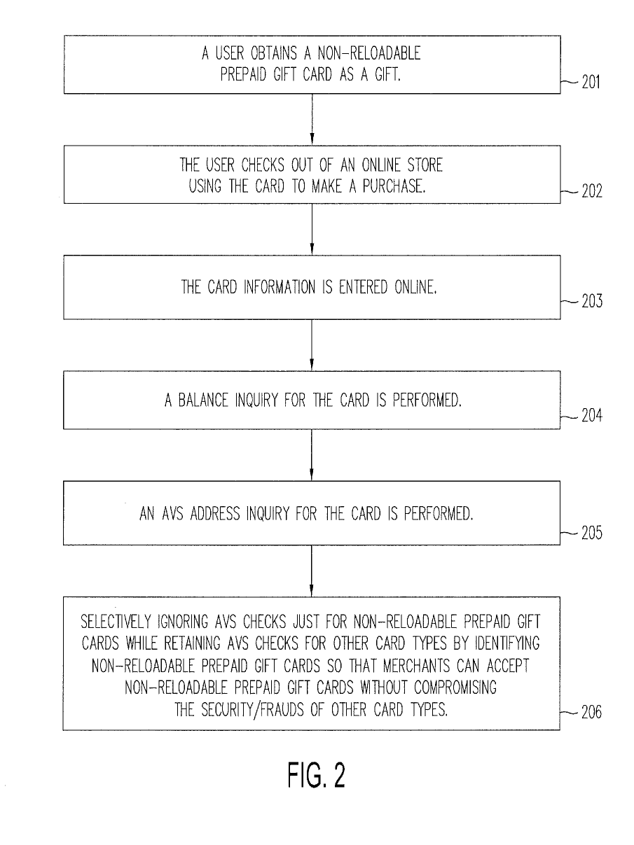

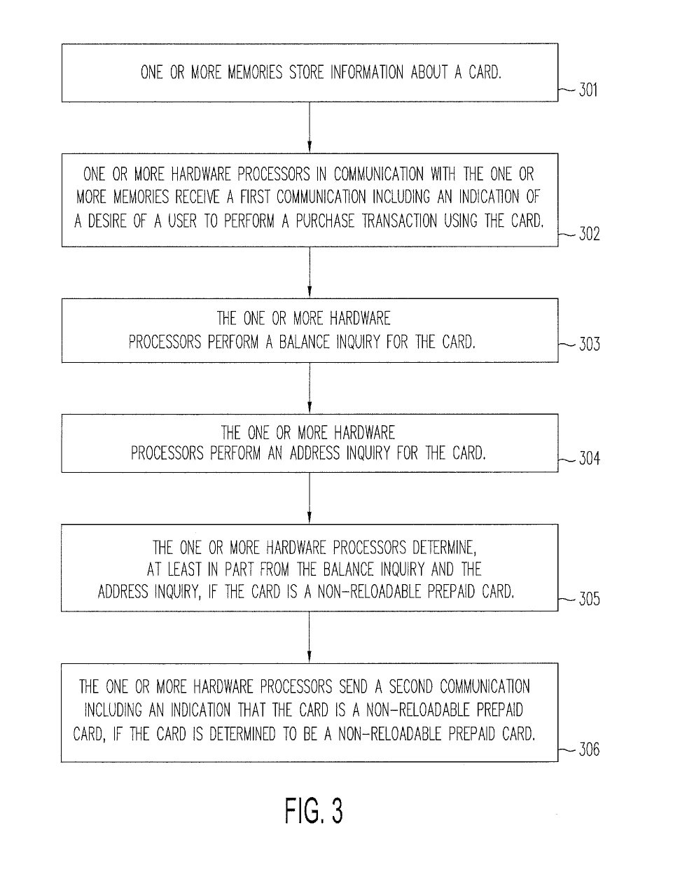

FIGS. 2 and 3 are flow charts that describe examples of operation of the system for identifying the non-reloadable prepaid card 110 according to embodiments thereof. Identifying the non-reloadable prepaid card 110 can include determining that a card is a no-reloadable prepaid card rather than some other type of card, such as a credit card, debit card, and/or a reloadable prepaid card. Note that one or more of the steps described herein may be combined, omitted, or performed in a different order, as desired or appropriate.

FIG. 2 is a flow chart showing a method for identifying the non-reloadable prepaid card 110, according to an embodiment. The user can obtain the non-reloadable prepaid card 110, as shown in step 201. For example, the non-reloadable prepaid card 110 can be a gift. Since the prepaid card is non-reloadable, it can only be loaded with money once, such as prior to purchase, at the time or purchase, or after purchase of the prepaid card.

The user can check out of the online store 101, as shown in step 202. For example, the user can place any items to be purchased in a virtual checkout basket of the online store 101.

The merchant device 102 can be located at the website of the online store 101. The website of the online store 101 can be located at a facility of the merchant, can be collocated at a service provider's facility, can be collocated at a facility of the server 103, or can be at any other location.

Information regarding the non-reloadable prepaid card 110 can be entered online, as shown in step 203. The non-reloadable prepaid card 110 can be swiped, read, imaged, or otherwise provide, such a by using a card reader, camera, or other device of the user. The information can be entered manually by the user, such as via a keyboard or key pad of the user device 120.

The non-reloadable prepaid card 110 can be embodied within the user's user device 120, as discussed above. The user's user device 120 can communicate with the merchant device 102 to effect reading of the non-reloadable prepaid card 110. Such communication can be via WiFi, Bluetooth, near field communication (NFC), or any other means.

A balance inquiry for the non-reloadable prepaid card 110 can be performed, as shown in step 204. The balance inquiry can be performed by the merchant, the payment provider, or anyone else.

An AVS address inquiry for the non-reloadable prepaid card 110 can be performed, as shown in step 205. The AVS inquiry can be performed by the merchant, the payment provider, or anyone else.

AVS checks can be selectively ignored just for non-reloadable prepaid gift cards while retaining AVS checks for other card types by identifying non-reloadable prepaid gift cards so that merchants can accept non-reloadable prepaid gift cards without compromising the security/frauds of other card types, as shown in step 206. The card can be identified as the non-reloadable prepaid card 110 if the balance inquiry returns an indication that there is a balance, e.g., a positive balance, remaining on the card and if the an address inquiry returns an indication that the non-reloadable prepaid card 110 is not supported or that information regarding the non-reloadable prepaid card 110 is not available, as shown in step 206. A positive balance sufficient to cover the online purchase can be required for authorization of the online purchase transaction.

FIG. 3 is a flow chart showing further detail of the method for identifying the non-reloadable prepaid card 110, according to an embodiment. One or more memories (such as memory 111, memory 122, and/or memory 106) can store information about a card, such as information about a non-reloadable prepaid card 110 or an account associated therewith, as shown in step 301. One or more hardware processors (such as processor 112, processor 121, or processor 105) can be in communication with the one or more memories and can receive a first communication including an indication of a desire of a user to perform an online purchase transaction using the card, as shown in step 302.

The one or more hardware processors can perform a balance inquiry for the card, as shown in step 303. The one or more hardware processors can perform an address inquiry for the card, as shown in step 304. The balance inquiry and/or the address inquiry can be performed via a card processor. The address inquiry can be an AVS inquiry, as discussed herein.

The one or more hardware processors can determine, at least in part from the balance inquiry and the address inquiry, if the card is a non-reloadable prepaid card 110, as shown in step 305. The one or more hardware processors can send a second communication including an indication that the card is the non-reloadable prepaid card 110, if the card is determined to be a non-reloadable card, as shown in step 306. The card can be determined to be a non-reloadable prepaid card and the online purchase transaction can be determined to be authorized, at least in part, if the balance inquiry returns an indication that there is a positive balance and if the address inquiry returns an indication that the non-reloadable prepaid card is not supported or that information regarding the non-reloadable prepaid card is not available.

In implementation of the various embodiments, embodiments of the invention may comprise a personal computing device, such as a personal computer, laptop, PDA, cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as a processing component (e.g., processor, micro-controller, digital signal processor (DSP), etc.), a system memory component (e.g., RAM), a static storage component (e.g., ROM), a disk drive component (e.g., magnetic or optical), a network interface component (e.g., modem or Ethernet card), a display component (e.g., CRT or LCD), an input component (e.g., keyboard or keypad), and/or cursor control component (e.g., mouse or trackball). In one embodiment, a disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the invention.

Payment processing can be through known methods, such as transaction details being communicated to the payment provider through the app, the payment provider processing the details, which may include user account and identifier information and authentication, merchant information, and transaction details. The user account may be accessed to determine if any restrictions or limitations may prevent the transaction from being approved. If approved, the payment provider may send a notification to the merchant and/or the user.

Various limitations can be place upon the use of the non-reloadable prepaid card 110, according to an embodiment. For example, the non-reloadable prepaid card 110 can be limited to use on specified days, at specified times, at specified location, at specified merchants, to purchase specified types of products (e.g., food and clothing), and/or to purchase specified products. The non-reloadable prepaid card 110 can be limited to use by specified people.

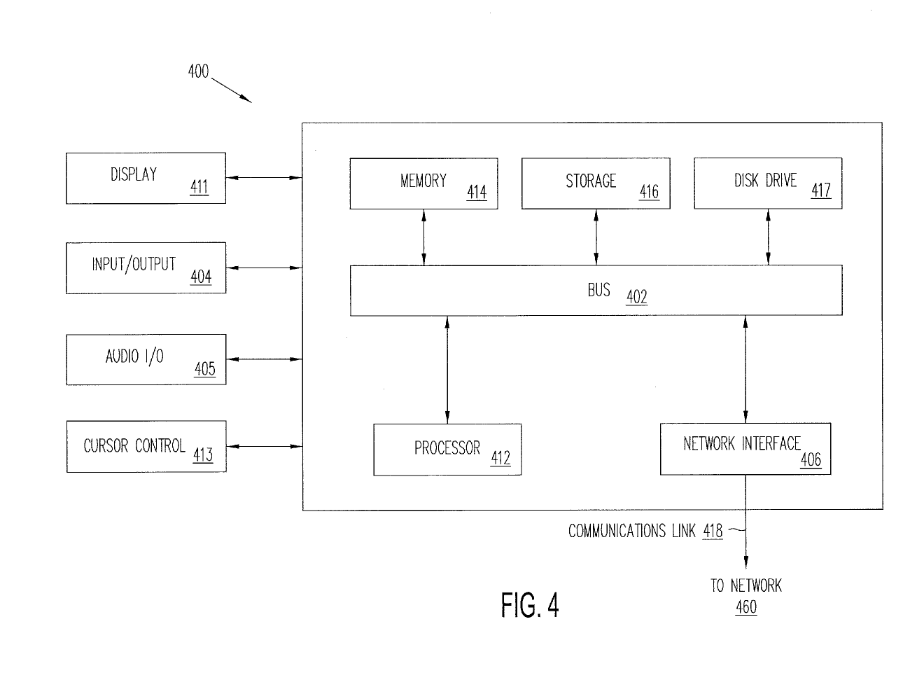

FIG. 4 is a block diagram of a computer system 400 suitable for implementing one or more embodiments of the present disclosure. In various implementations, the PIN pad and/or merchant terminal may comprise a computing device (e.g., a personal computer, laptop, smart phone, tablet, PDA, Bluetooth device, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as a user device, a merchant server, or a payment provider server via network 460. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable and executable media include, for example, floppy disk, flexible disk, hard disk, magnetic tape, any other magnetic medium, CD-ROM, any other optical medium, punch cards, paper tape, any other physical medium with patterns of holes, RAM, ROM, E2PROM, FLASH-EPROM, any other memory chip or cartridge, carrier wave, or any other medium from which a computer is adapted to read.

In various embodiments, execution of instruction sequences for practicing the invention may be performed by a computer system. In various other embodiments, a plurality of computer systems coupled by a communication link (e.g., LAN, WLAN, PTSN, or various other wired or wireless networks) may perform instruction sequences to practice the invention in coordination with one another. Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code and/or data, may be stored on one or more computer readable and executable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

As used herein, the term “store” can include any business or place of business. The store can be a brick and mortar store or an online store. The store can be any person or entity that sells a product. Although some embodiments disclosed herein find particular application with respect to use with online stores, other embodiments can be used in brick and mortar stores.

As used herein, the term “product” can include any item or service. Thus, the term “product” can refer to physical products, digital goods, services, or anything for which a user can make a payment, including charitable donations. A product can be anything that can be sold. Examples of products include cellular telephones, concerts, meals, hotel rooms, automotive repair, haircuts, digital music, and books. The product can be a single item or a plurality of items. For example, the product can be a tube of toothpaste, a box of laundry detergent, three shirts, and a donut.

As used herein, the term “merchant” can include any seller of products. The term merchant can include a store. The products can be sold from a store or in any other manner.

As used herein, the term “mobile device” can include any portable electronic device that can facilitate data communications, such as via a cellular network and/or the Internet. Examples of mobile devices include cellular telephones, smart phones, tablet computers, and laptop computers.

As used herein, the term “network” can include one or more local area networks (LANs) such as business networks, one or more wide area networks (WANs) such as the Internet, one or more cellular telephone networks, or any other type or combination of electronic or optical networks.

As used herein, the term “card” can refer to any card or other device that can be used to make a purchase in place of cash. For example, the card can be a bank card, credit card, debit card, gift card, or other device. The card can be a token, such as a hardware token or a software token. The card can be stored in and/or displayed upon a user device, such as a cellular telephone.

Prepaid cards can include both reloadable cards and non-reloadable cards. Debit cards and some gift cards are examples of reloadable cards. Some gift cards are examples of non-reloadable cards.

As used herein, the term “card-not-present purchase transaction” can refer to a purchase transaction wherein the user does not physically provide the card and/or swipe the card. An example of a “card-not-present purchase transaction” is an online purchase transaction.

Although the discussion and examples provided herein tend to include use for online sales, those skilled in the art will appreciate that other uses (non-online sales) are likewise contemplated. Embodiments can be used in other situations, such as when the non-reloadable prepaid card is unavailable to the merchant during an online purchase transaction. For example, the user may not have procession of the non-reloadable prepaid card, but may have the necessary information (such as a photographic or data image of the card). Embodiments can find particular application for card-not-present use case such as online transactions.

According to an embodiment, users can transfer a card balances. For example, mobile users can load a payment provider balance, such as a PayPal balance, from prepaid gift cards. For example, the user can take picture of the card (or otherwise provide information regarding the card) and transfer the remaining balance to the user's payment provider account without having to enter billing address.

If the balance inquiry results in a positive balance for the non-reloadable prepaid card and the AVS inquiry returns an indication that the non-reloadable prepaid card is not supported and/or that information regarding the non-reloadable prepaid card is not available, then the card can be identified as a non-reloadable prepaid card. Such identification can be done with sufficient reliability to facilitate, at least in part, the authorization of an online purchase transaction using the card.

Thus, a merchant or the like can identify, with at least some degree of confidence, a non-reloadable prepaid gift card without obtaining additional support from a card processor or card brand. In this manner, a payment provider, such as PayPal, Inc., can provide a more streamlined checkout experience when a user pays for online purchases with a non-reloadable prepaid gift card. The billing address fields can be hidden so that the user does not have to enter the billing address, since the payment provider can provide the billing address for the AVS inquiry.

Embodiments disclosed herein can be used to facilitate purchases from online stores, as well as from brick and mortar stores. Embodiments disclosed herein are particularly suited for card-not-present purchase transactions, such as online transactions. The methods and systems disclosed herein can be used to facilitate purchases using a payment provider. For example, the non-reloadable prepaid card can be used to pay for a portion of a purchase made using a payment provider.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Having thus described various example embodiments of the disclosure, persons of ordinary skill in the art will recognize that changes may be made in form and detail without departing from the scope of the invention. Thus, the invention is limited only by the claims.

1. A system comprising:
one or more memories storing information about a card;
one or more hardware processors in communication with the one or more memories and operable to:
receive a first communication including an indication of a desire of a user to perform a purchase transaction using the card;
perform a balance inquiry for the card;
perform an address inquiry for the card;
determine, at least in part from the balance inquiry and the address inquiry, if the card is a non-reloadable prepaid card;
send a second communication including an indication that the card is the non-reloadable prepaid card if the card is determined to be the non-reloadable prepaid card; and
wherein the card is determined to be the non-reloadable prepaid card, at least in part, if the balance inquiry returns an indication that there is a positive balance and if the address inquiry returns an indication that the non-reloadable prepaid card is not supported or that information regarding the non-reloadable prepaid card is not available.

2. The system of claim 1, wherein a billing address of the card is not used for the purchase transaction.

3. The system of claim 1, wherein the address inquiry is an Address Verification System (AVS) inquiry.

4. The system of claim 1, wherein the indication that the non-reloadable prepaid card is not supported or that information regarding the non-reloadable prepaid card is not available is provided by the Address Verification System (AVS) inquiry returning a code of U or a code of S.

5. The system of claim 1, wherein the one or more hardware processors are further operable to determine if the positive balance is sufficient to cover the purchase transaction and only determining that the purchase transaction is to be authorized if the positive balance is sufficient to cover the purchase transaction.

6. The system of claim 1, wherein the first communication is received from an online merchant.

7. The system of claim 6, wherein the second communication is sent to the online merchant.

8. A method comprising:
storing, in one or more memories, information about a card;
receiving, via one or more hardware processors in communication with the one or more memories, a first communication including an indication of a desire of a user to perform a purchase transaction using the card;
performing, via the one or more hardware processors, a balance inquiry for the card;
performing, via the one or more hardware processors, an address inquiry for the card;
determining, via the one or more hardware processors, at least in part from the balance inquiry and the address inquiry, if the card is a non-reloadable prepaid card;
sending, via the one or more hardware processors, a second communication including an indication that the card is the non-reloadable prepaid card if the card is determined to be the non-reloadable prepaid card; and
wherein the card is determined to be the non-reloadable prepaid card, at least in part, if the balance inquiry returns an indication that there is a positive balance and if the address inquiry returns an indication that the non-reloadable prepaid card is not supported or that information regarding the non-reloadable prepaid card is not available.

9. The method of claim 8, wherein a billing address of the card is not used for the purchase transaction.

10. The method of claim 8, wherein the address inquiry is an Address Verification System (AVS) inquiry.

11. The method of claim 8, wherein the indication that the non-reloadable prepaid card is not supported or that information regarding the non-reloadable prepaid card is not available is provided by the Address Verification System (AVS) inquiry returning a code of U or a code of S.

12. The method of claim 8, further comprising determining, via the one or more hardware processors, if the positive balance is sufficient to cover the purchase transaction and only determining that the purchase transaction is to be authorized if the positive balance is sufficient to cover the purchase transaction.

13. The method of claim 8, wherein the first communication is received from an online merchant.

14. The method of claim 13, wherein the second communication is sent to the online merchant.

15. A computer program product comprising a non-transitory computer readable medium having computer readable and executable code for instructing one or more processors to perform a method, the method comprising:
storing information about a card;
receiving a first communication including an indication of a desire of a user to perform a purchase transaction using the card;
performing a balance inquiry for the card;
performing an address inquiry for the card;
determining at least in part from the balance inquiry and the address inquiry, if the card is a non-reloadable prepaid card;
sending a second communication including an indication that the card is the non-reloadable prepaid card if the card is determined to be the non-reloadable prepaid card; and
wherein the card is determined to be the non-reloadable prepaid card, at least in part, if the balance inquiry returns an indication that there is a positive balance and if the address inquiry returns an indication that the non-reloadable prepaid card is not supported or that information regarding the non-reloadable prepaid card is not available.

16. The computer program product of claim 15, wherein a billing address of the card is not used for the purchase transaction.

17. The computer program product of claim 15, wherein the address inquiry is an Address Verification System (AVS) inquiry.

18. The computer program product of claim 15, wherein the indication that the non-reloadable prepaid card is not supported or that information regarding the non-reloadable prepaid card is not available is provided by the Address Verification System (AVS) inquiry returning a code of U or a code of S.

19. The computer program product of claim 15, further comprising determining if the positive balance is sufficient to cover the purchase transaction and only determining that the purchase transaction is to be authorized if the positive balance is sufficient to cover the purchase transaction.

20. The computer program product of claim 15, wherein the first communication is received from an online merchant and the second communication is sent to the online merchant.
